(19) United States
(12) Patent Application Publication
(10) Pub. No.: US 2026/0170259 A1
(43) Pub. Date: Jun. 18, 2026

(54) SYSTEMS AND METHODS FOR INTENT HEALTH OPTIMIZATION IN A BOT FLOW ARCHITECTURE

(71) Applicant: GENESYS CLOUD SERVICES, INC., MENLO PARK, CA (US)

(72) Inventors: SYED AREEB AHMAD, HYDERABAD (IN); BASIL GEORGE, HYDERABAD (IN); RAMASUBRAMANIAN SUNDARAM, HYDERABAD (IN)

(73) Assignee: GENESYS CLOUD SERVICES, INC., MENLO PARK, CA (US)

(21) Appl. No.: 18/980,824

(22) Filed: Dec. 13, 2024

(51) Int. Cl. G06F 40/35; G06F 40/284; G06F 40/289; G06F 40/40

(52) U.S. Cl. CPC G06F 40/35; G06F 40/284; G06F 40/289; G06F 40/40

(57) ABSTRACT

A method for determining representative utterances from input utterances to generate paraphrased utterances with healthy intents which optimizes intent health in a bot flow architecture. The conversational bot flow architecture includes a machine learning model trained for natural language understanding (NLU) within a NLU domain that is defined by a collection of intents and sets of associated utterances. The method includes obtaining, by a relevance processing module an overall relevance score of the input utterances based on a vector similarity, a key phrase quality score, a non-ideal length penalty or any combination thereof; obtaining, by a diversity processing module an overall diversity score between a candidate input utterance and previously selected representative utterances, based on both a token value difference and a token order difference; and retrieving, by an adaptive utterance retrieval module selected representative utterances based on the overall relevance score and the overall diversity, where the selected representative utterances are used to generate paraphrased utterances with healthy intents.

### FIELD OF THE INVENTION

The present invention generally relates to customer relations services and customer relations management via contact centers and associated cloud-based systems. More particularly, but not by way of limitation, the present invention pertains to systems and methods for intent health optimization in a bot flow architecture to enhance quality of conversation in conversational bots.

### BACKGROUND

Conversational bots comprise software that allow machines to understand, process, and respond to humans through communication channels, such as a chat, simulating human conversation. An intelligent bot, driven by artificial intelligence (AI), can participate in live, contextually relevant dialogues with the end users who are using natural language. The quality of conversational bots depends on the health of a bot which may be assessed using parameters, such as the complexity of the bot flow architecture or the performance thereof. The complexity of bot flow architecture may be defined in terms of complexity or confusability of dialogue flow definition, quality of knowledge articles being created and intent-utterance association. Performance of the bot-flow architecture may be evaluated based on factors, such as utterance count per intent, intent health, or identification of conflicting and outlier utterances. If it is determined that the intent health is poor during a performance evaluation of the bot flow architecture, a bot author may need to manually introduce additional utterances aligned with a healthy intent. This manual process is inefficient and cumbersome.

### BRIEF DESCRIPTION OF THE INVENTION

Techniques are provided for intent health optimization in a bot flow architecture to enhance the quality of conversation in conversational bots.

In an example embodiment, the method described herein includes determining representative utterances from input utterances to generate paraphrased utterances with healthy intents, by obtaining, by a relevance processing module an overall relevance score of the input utterances based on a vector similarity, a key phrase quality score, a non-ideal length penalty or any combination thereof. Further, a diversity processing module obtains an overall diversity score between a candidate input utterance and previously selected representative utterances, based on both a token value difference and a token order difference and an adaptive utterance retrieval module retrieves selected representative utterances based on the overall relevance score and the overall diversity score.

In an example embodiment, the method described herein includes generating a refined set of paraphrased utterances from the selected utterances by grouping, into batches, the selected representative utterances of a common intent and utilizing a default model configuration on the selected representative batches to generate an initial set of paraphrased utterances and evaluating, the initial set of paraphrased utterances based on control metrics, wherein the control metrics are an embedding similarity, a lexical variation, a syntactic variation, or a combination thereof. Further in response to the evaluating, the initial set of paraphrased utterances are refined.

In an example embodiment, the method described herein includes filtering, the refined set of paraphrased utterances based on a readability score and in response to filtering, reranking the refined set of paraphrased utterances. Further, a dynamic trade-off parameter is assigned to the to the refined set of paraphrased utterances to obtain the paraphrased utterances with healthy intents wherein, the dynamic trade off parameter balances between relevance and diversity of the paraphrased utterances with healthy intents.

In an example embodiment, the method described herein includes determining the vector similarity by generating embeddings of the input utterances wherein the embeddings are fixed-size dense vector representation of the input utterances and generating a centroid of the embeddings of the input utterances for the specific intent to obtain an intent representative vector.

In an example embodiment, the method described herein includes obtaining the key phrase quality score by extracting candidate key phrases from the input utterance and generating embeddings of the extracted candidate key phrases to obtain candidate key phrase vectors. Further, a semantic similarity between candidate key phrase vector and the intent representative vector for the specific intent, is estimated to obtain pairwise quality scores wherein the top pair wise quality scores are aggregated to obtain the key phrase quality score.

In another example embodiment, the method described herein includes determining the non-ideal length penalty by estimating an ideal length of the input utterance based on a length of all the input utterances with the specific intent wherein determining the non-ideal length penalty includes varying a stringency parameter.

In another example embodiment, the method described herein includes evaluating the token value difference by performing a union operation of the candidate input utterance token list with a token list of each of the previously selected representative utterances with the specific intent to obtain total tokens. Further an intersection operation is performed on the total tokens obtained to eliminate tokens common to both the candidate input utterances and each of the previously selected representative utterances.

In an example embodiment, the method described herein includes evaluating the token order difference by determining an anchor point for the input utterance by a token order matching algorithm and recursively applying the token order matching algorithm to portions before and after the anchor point.

In an example embodiment, the method described herein includes retrieving the selected representative utterance by determining the overall diversity of the all the relevant utterances except the utterance with the highest relevant score.

In an example embodiment, the method described herein includes retrieving the selected representative utterance by adaptively varying a trade-off parameter.

In an example embodiment, the method described herein includes adaptively varying a trade-off parameter by assigning a high priority to the overall relevance score between time intervals t₀ to tₜₕ where t₀ represents the initial time interval and tₜₕ represents a threshold time interval closer to the initial time interval and assigning high priority to the overall diversity score as the number of input utterance increases.

In an example embodiment, the method described herein includes a Claude Large Language model or a Flan Model in the paraphrase generation and evaluation module.

These and other features of the present application will become more apparent upon review of the following detailed description of the example embodiments when taken in conjunction with the drawings and the appended claims.

### BRIEF DESCRIPTION OF THE DRAWINGS

A more complete appreciation of the present invention will become more readily apparent as the invention becomes better understood by reference to the following detailed description when considered in conjunction with the accompanying drawings, in which like reference symbols indicate like components, wherein:

FIG. 1 depicts a schematic block diagram of a computing device in accordance with exemplary embodiments of the present invention and/or with which exemplary embodiments of the present invention may be enabled or practiced;

FIG. 2 depicts a schematic block diagram of a communications infrastructure or contact center in accordance with exemplary embodiments of the present invention and/or with which exemplary embodiments of the present invention may be enabled or practiced;

FIG. 3 depicts a simplified block diagram of an intent health optimization system in accordance with exemplary embodiments of the present invention;

FIG. 4 depicts a flowchart illustrating a method for intent health optimization in accordance with exemplary embodiments of the present invention;

FIG. 5 depicts a flowchart illustrating a method for preprocessing the input utterance in accordance with exemplary embodiments of the present invention;

FIG. 5A depicts a flowchart for illustrating a process for key phrase quality score in accordance with exemplary embodiments of the present invention;

FIG. 5B depicts a flowchart for illustrating a process for evaluating a non-ideal length penalty in accordance with exemplary embodiments of the present invention;

FIG. 5C depicts a flowchart for illustrating a process for obtaining the overall diversity score in accordance with exemplary embodiments of the present invention; and

FIG. 5D depicts a flowchart illustrating a process utilized by the adaptive utterance retrieval algorithm in accordance with exemplary embodiments of the present invention.

### DETAILED DESCRIPTION

For the purpose of understanding of the principles of the invention, reference will now be made to the exemplary embodiments illustrated in the drawings and specific language will be used to describe the same. It will be apparent, however, to one having ordinary skill in the art that the detailed material provided in the examples may not be needed to practice the present invention. In other instances, well-known materials or methods have not been described in detail to avoid obscuring the present invention. Additionally, further modification in the provided examples or application of the principles of the invention, as presented herein, are contemplated as would normally occur to those skilled in the art. Particular features, structures or characteristics may be combined in any suitable combinations and/or sub-combinations in one or more embodiments or examples. Those skilled in the art will recognize that various embodiments may be computer implemented using many different types of data processing equipment, with embodiments being implemented as a system, method, or computer program product. Example embodiments, thus, may take the form of a hardware embodiment, a software embodiment, or combination thereof.

### Introduction

Modern day contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize automated processes in place of live agents, such as conversational bots. The structure and sequence of interactions between the conversational bot and its users is defined by a bot flow architecture. The bot flow architecture includes elements, such as a dialog flow definition, a natural language understanding (NLU) domain and a knowledge base.

Techniques are disclosed herein for intent health optimization in the bot flow architecture by generating paraphrased utterances with healthy intents which replaces utterances linked to irrelevant intents, thereby improving performance of the bot flow architecture. While the techniques described herein are not tailored to any specific machine learning model, the techniques work best with any model utilizing word embeddings or their variations as features. Further, for simplicity, it may be assumed that the NLU domain is mono-lingual. In the case of multi-lingual NLU domains where intents and utterances belonging to multiple languages are separately defined, intent health may be computed for each language independently and in parallel without any major changes to the system described.

### Computing Device

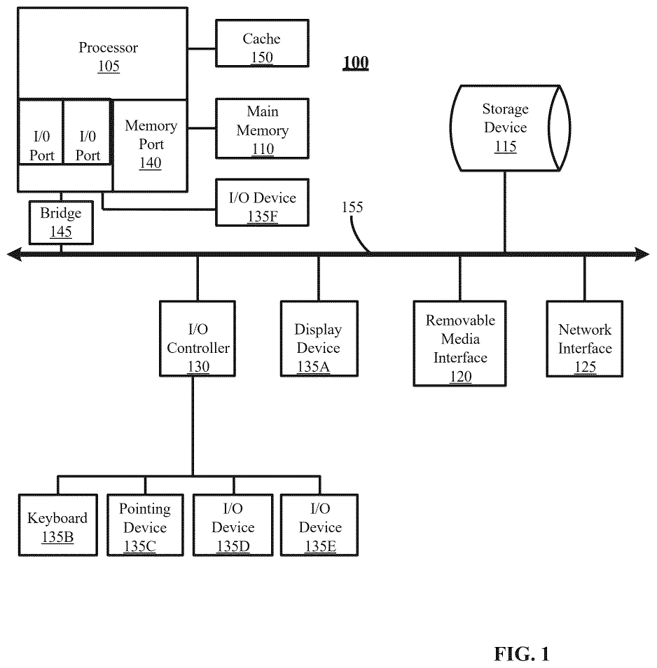

It will be appreciated that the systems and methods of the present invention may be computer implemented using different forms of data processing equipment, for example, digital microprocessors and associated memory, executing appropriate software programs. By way of background, FIG. 1 illustrates a schematic block diagram of an exemplary computing device 100 in accordance with embodiments of the present invention and/or with which those embodiments may be enabled or practiced. It should be understood that FIG. 1 is provided as a non-limiting example.

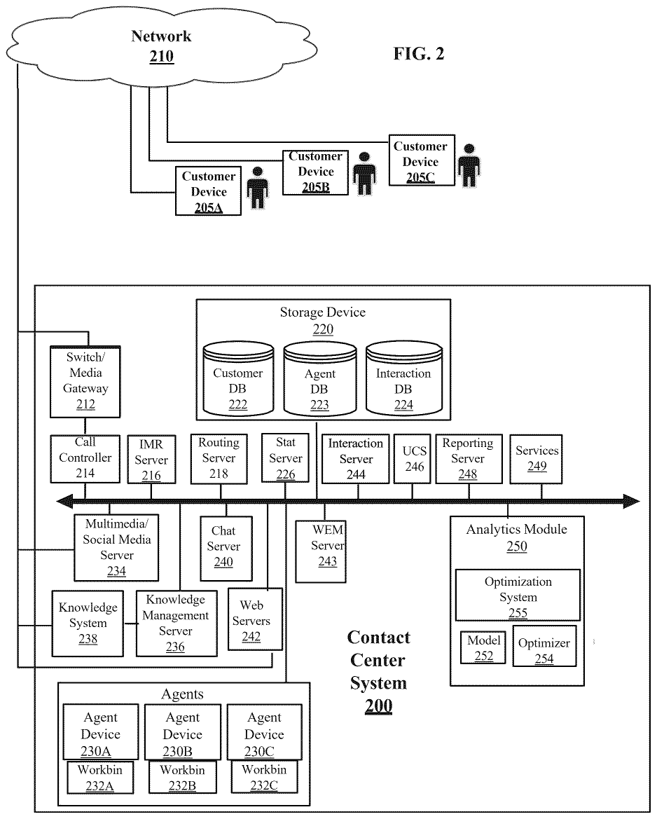

The computing device 100, for example, may be implemented via firmware (e.g., an application-specific integrated circuit), hardware, or a combination of software, firmware, and hardware. Each of the servers, controllers, switches, gateways, engines, and/or modules in the following figures (which collectively may be referred to as servers or modules) may be implemented via one or more of the computing devices 100. As an example, the various servers may be a process running on one or more processors of one or more computing devices 100, which may be executing computer program instructions and interacting with other systems or modules to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described in the following figures, such as for example, the contact center system 200 of FIG. 2 the various servers and computer devices thereof may be located on local computing devices 100 (i.e., on-site or at the same physical location as contact center agents), remote computing devices 100 (i.e., off-site or in a cloud computing environment, for example, in a remote data center connected to the contact center via a network), or some combination thereof. Functionality provided by servers located on off-site computing devices may be accessed and provided over a virtual private network (VPN), as if such servers were on-site, or the functionality may be provided using a software as a service (SaaS) accessed over the Internet using various protocols, such as by exchanging data via extensible markup language (XML), JSON, and the like.

As shown in the illustrated example, the computing device 100 may include a central processing unit (CPU) or processor 105 and a main memory 110. The computing device 100 may also include a storage device 115, removable media interface 120, network interface 125, I/O controller 130, and one or more input/output (I/O) devices 135, which as depicted may include an, display device 135A, keyboard 135B, and pointing device 135C. The computing device 100 further may include additional elements, such as a memory port 140, a bridge 145, I/O ports, one or more additional input/output devices 135D, 135E, 135F, and a cache memory 150 in communication with the processor 105.

The processor 105 may be any logic circuitry that responds to, and processes instructions fetched from the main memory 110. For example, the processor 105 may be implemented by an integrated circuit, e.g., a microprocessor, microcontroller, or graphics processing unit, or in a field-programmable gate array or application-specific integrated circuit. As depicted, the processor 105 may communicate directly with the cache memory 150 via a secondary bus or backside bus. The main memory 110 may be one or more memory chips capable of storing data and allowing stored data to be accessed by the central processing unit 105. The storage device 115 may provide storage for an operating system, which controls scheduling tasks and access to system resources, and other software. Unless otherwise limited, the computing device 100 may include an operating system and software capable of performing the functionality described herein.

As depicted in the illustrated example, the computing device 100 may include a wide variety of I/O devices 135, one or more of which may be connected via the I/O controller 130. Input devices, for example, may include a keyboard 135B and a pointing device 135C, e.g., a mouse or optical pen. Output devices, for example, may include video display devices, speakers, and printers. The I/O devices 135 and/or the I/O controller 130 may include suitable hardware and/or software for enabling the use of multiple display devices. The computing device 100 may also support one or more removable media interfaces 120, such as a disk drive, USB port, or any other device suitable for reading data from or writing data to computer readable media. More generally, the I/O devices 135 may include any conventional devices for performing the functionality described herein.

Unless otherwise limited, the computing device 100 may be any workstation, desktop computer, laptop or notebook computer, server machine, virtualized machine, mobile or smart phone, portable telecommunication device, media playing device, or any other type of computing, telecommunications or media device, without limitation, capable of performing the operations and functionality described herein. The computing device 100 may include a plurality of such devices connected by a network or connected to other systems and resources via a network. Unless otherwise limited, the computing device 100 may communicate with other computing devices 100 via any type of network using any conventional communication protocol. Further, the network may be a virtual network environment where various network components are virtualized.

### Contact Center

With reference now to FIG. 2, a communications infrastructure or contact center system (or simply “contact center”) 200 is shown in accordance with exemplary embodiments of the present invention and/or with which exemplary embodiments of the present invention may be enabled or practiced. By way of background, customer service providers generally offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between agents and customers may be conducted over a variety of communication channels, such as for example, via voice (e.g., telephone calls or voice over IP or VoIP calls), video (e.g., video conferencing), text (e.g., emails and text chat), screen sharing, co-browsing, or the like.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize automated processes in place of live agents, such as interactive voice response (IVR) systems, interactive media response (IMR) systems, internet robots or “bots”, automated chat modules or “conversational bots”, and the like.

Referring specifically to FIG. 2, the contact center 200 may be used by a customer service provider to provide various types of services to customers. For example, the contact center 200 may be used to engage and manage interactions in which automated processes (or bots) or human agents communicate with customers. The contact center 200 may be an in-house facility of a business or enterprise for performing the functions of sales and customer service relative to products and services available through the enterprise. In another aspect, the contact center 200 may be operated by a service provider that contracts to provide customer relation services to a business or organization. Further, the contact center 200 may be deployed on equipment dedicated to the enterprise or third-party service provider, and/or deployed in a remote computing environment, such as for example, a private or public cloud environment with infrastructure for supporting multiple contact centers for multiple enterprises. The contact center 200 may include software applications or programs, which may be executed on premises or remotely or some combination thereof. It should further be appreciated that the various components of the contact center 200 may be distributed across various geographic locations.

Unless otherwise specifically limited, any of the computing elements of the present invention may be implemented in cloud-based or cloud computing environments. As used herein, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, or some combination thereof), service models (e.g., Software as a Service (“SaaS”), Platform as a Service (“PaaS”), Infrastructure as a Service (“IaaS”), and deployment models (e.g., private cloud, community cloud, public cloud, hybrid cloud, or some combination thereof). Often referred to as a “serverless architecture”, a cloud execution model generally includes a service provider dynamically managing an allocation and provisioning of remote servers for achieving a desired functionality.

In accordance with the illustrated example of FIG. 2, the components or modules of the contact center 200 may include: a plurality of customer devices 205; communications network (or simply “network”) 210; switch/media gateway 212; call controller 214; interactive media response (IMR) server 216; routing server 218; storage device 220; statistics server 226; plurality of agent devices 230 that each have a workbin 232; multimedia/social media server 234; knowledge management server 236 coupled to a knowledge system 238; chat server 240; web servers 242; interaction server 244; universal contact server (or “UCS”) 246; reporting server 248; media services server 249; and an analytics module 250. It should be understood that any of the computer-implemented components, modules, or servers described in relation to FIG. 2 or in any of the following figures may be implemented via computing devices, such as the computing device 100 of FIG. 1. As will be seen, the contact center 200 generally manages resources (e.g., personnel, computers, telecommunication equipment, or some combination thereof) to enable the delivery of services via telephone, email, chat, or other communication mechanisms. The various components, modules, and/or servers of FIG. 2 (and other figures included herein) each may include one or more processors executing computer program instructions and interacting with other system components for performing the various functionalities described herein. Further, the terms “interaction” and “communication” are used interchangeably, and generally refer to any real-time and non-real-time interaction that uses any communication channel including, without limitation, telephone calls (PSTN or VOIP calls), emails, voicemails, video, chat, screen-sharing, text messages, social media messages, WebRTC calls, or some combination thereof. Access to and control of the components of the contact system 200 may be affected through user interfaces (UIs) which may be generated on the customer devices 205 and/or the agent devices 230.

Customers desiring to receive services from the contact center 200 may initiate inbound communications (e.g., telephone calls, emails, chats, or some combination thereof) to the contact center 200 via a customer device 205. While FIG. 2 shows two such customer devices it should be understood that any number may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center 200, such as telephone calls, emails, chats, text messages, web-browsing sessions, and other multi-media transactions. Inbound and outbound communications from and to the customer devices 205 may traverse the network 210, with the nature of network typically depending on the type of customer device being used and form of communication. As an example, the network 210 may include a communication network of telephone, cellular, and/or data services. The network 210 may be a private or public switched telephone network (PSTN), local area network (LAN), private wide area network (WAN), and/or public WAN, such as the Internet. Further, the network 210 may include a wireless carrier network including a code division multiple access network, global system for mobile communications (GSM) network, or any wireless network/technology conventional in the art.

The switch/media gateway 212 may be coupled to the network 210 for receiving and transmitting telephone calls between customers and the contact center 200. The switch/media gateway 212 may include a telephone or communication switch configured to function as a central switch for agent routing within the center. The switch may be a hardware switching system or implemented via software. For example, the switch 215 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. In general, the switch/media gateway 212 establishes a voice connection between the customer and the agent by establishing a connection between the customer device 205 and agent device 230. The switch/media gateway 212 may be coupled to the call controller 214 which, for example, serves as an adapter or interface between the switch and the other routing, monitoring, and communication-handling components of the contact center 200. The call controller 214 may be configured to process PSTN calls, VOIP calls, or some combination thereof. The call controller 214 may include computer-telephone integration (CTI) software for interfacing with the switch/media gateway and other components. The call controller 214 may include a session initiation protocol (SIP) server for processing SIP calls. The call controller 214 may also extract data about an incoming interaction, such as the customer's telephone number, IP address, or email address, and then communicate these with other contact center components in processing the interaction.

The interactive media response (IMR) server 216 enables automated processes, such as bot or virtual assistant functionality. Specifically, the IMR server 216 may be similar to an interactive voice response (IVR) server, except that the IMR server 216 is not restricted to voice and may also cover a variety of media channels. In an example illustrating voice, the IMR server 216 may be configured with an IMR script for querying customers on their needs. For example, a contact center for a bank may tell customers via the IMR script to “press 1” if they wish to retrieve their account balance. Through continued interaction with the IMR server 216, customers may receive service without needing to speak with an agent. The IMR server 216 may ascertain why a customer is contacting the contact center so to route the communication to the appropriate resource.

The routing server 218 routes incoming interactions. For example, once it is determined that an inbound communication should be handled by a human agent, functionality within the routing server 218 may select the most appropriate agent and route the communication thereto. This type of functionality may be referred to as predictive routing. Such agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described more below, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230, which may enhance the service the agent is able to provide.

Regarding data storage, the contact center 200 may include one or more mass storage devices represented generally by the storage device 220 for storing data in one or more databases. For example, the storage device 220 may store customer data that is maintained in a customer database 222. Such customer data may include customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database 223. Agent data maintained by the contact center 200 may include agent availability and agent profiles, schedules, skills, average handle time, or some combination thereof. As another example, the storage device 220 may store interaction data in an interaction database 224. Interaction data may include data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center 200 in ways that facilitate the functionality described herein. For example, the servers or modules of the contact center 200 may query such databases to retrieve data stored therewithin or transmit data thereto for storage.

The statistics server 226 may be configured to record and aggregate data relating to the performance and operational aspects of the contact center 200. Such information may be compiled by the statistics server 226 and made available to other servers and modules, such as the reporting server 248, which then may produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center 200 may be communication devices configured to interact with the various components and modules of the contact center 200 to facilitate the functionality described herein. An agent device 230, for example, may include a telephone adapted for regular telephone calls or VoIP calls. An agent device 230 may further include a computing device configured to communicate with the servers of the contact center 200, perform data processing associated with operations, and interface with customers via voice, chat, email, and other multimedia communication mechanisms according to functionality described herein. While only two such agent devices are shown, any number may be present.

The multimedia/social media server 234 may be configured to facilitate media interactions (other than voice) with the customer devices 205 and/or the servers 242. Such media interactions may be related, for example, to email, voicemail, chat, video, text-messaging, web, social media, co-browsing, or some combination thereof. The multi-media/social media server 234 may take the form of any IP router conventional in the art with specialized hardware and software for receiving, processing, and forwarding multi-media events and communications.

The knowledge management server 234 may be configured to facilitate interactions between customers and the knowledge system 238. In general, the knowledge system 238 may be a computer system capable of receiving questions or queries and providing answers in response. The knowledge system 238 may include an artificially intelligent computer system capable of answering questions posed in natural language by retrieving information from information sources, such as encyclopedias, dictionaries, newswire articles, literary works, or other documents submitted to the knowledge system 238 as reference materials, as is known in the art.

The chat server 240 may be configured to conduct, orchestrate, and manage electronic chat communications with customers. Such chat communications may be conducted by the chat server 240 in such a way that a customer communicates with automated chatbots, human agents, or both. The chat server 240 may perform as a chat orchestration server that dispatches chat conversations among chatbots and available human agents. In such cases, the processing logic of the chat server 240 may be rules driven so to leverage an intelligent workload distribution among available chat resources. The chat server 240 further may implement, manage and facilitate user interfaces (also UIs) associated with the chat feature. The chat server 240 may be configured to transfer chats within a single chat session with a particular customer between automated and human sources. The chat server 240 may be coupled to the knowledge management server 234 and the knowledge systems 238 for receiving suggestions and answers to queries posed by customers during a chat so that, for example, links to relevant articles can be provided.

The web servers 242 provide site hosts for a variety of social interaction sites to which customers subscribe, such as Facebook, Twitter, Instagram, or some combination thereof. Though depicted as part of the contact center 200, it should be understood that the web servers 242 may be provided by third parties and/or maintained remotely. The web servers 242 may also provide webpages for the enterprise or organization being supported by the contact center 200. For example, customers may browse the webpages and receive information about the products and services of a particular enterprise. Within such enterprise webpages, mechanisms may be provided for initiating an interaction with the contact center 200, for example, via web chat, voice, or email. An example of such a mechanism is a widget, which can be deployed on the webpages or websites hosted on the web servers 242. As used herein, a widget refers to a user interface component that performs a particular function. In some implementations, a widget includes a GUI that is overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Such widgets may include additional user interfaces and be configured to access a variety of local resources (e.g., a calendar or contact information on the customer device) or remote resources via network (e.g., instant messaging, electronic mail, or social networking updates).

The interaction server 244 is configured to manage deferrable activities of the contact center and the routing thereof to human agents for completion. As used herein, deferrable activities include back-office work that can be performed off-line, e.g., responding to emails, attending training, and other activities that do not entail real-time communication with a customer.

The universal contact server (UCS) 246 may be configured to retrieve information stored in the customer database 222 and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer, such as data related to comments from agents, customer communication history, and the like. Each of these data types then may be stored in the customer database 222 or on other modules and retrieved as functionality described herein requires.

The reporting server 248 may be configured to generate reports from data compiled and aggregated by the statistics server 226 or other sources. Such reports may include near real-time reports or historical reports and concern the state of contact center resources and performance characteristics, such as for example, average wait time, abandonment rate, agent occupancy. The reports may be generated automatically or in response to a request and used toward managing the contact center in accordance with functionality described herein.

The media services server 249 provides audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, audio and video transcoding, secure real-time transport protocol (SRTP), audio or video conferencing, call analysis, keyword spotting, or some combination thereof.

The analytics module 250 may be configured to perform analytics on data received from a plurality of different data sources as functionality described herein may require. The analytics module 250 may also generate, update, train, and modify predictors or models, such as machine learning model 251 and/or models 253, based on collected data. To achieve this, the analytics module 250 may have access to the data stored in the storage device 220, including the customer database 222 and agent database 223. The analytics module 250 also may have access to the interaction database 224, which stores data related to interactions and interaction content (e.g., audio and transcripts of the interactions and events detected therein), interaction metadata (e.g., customer identifier, agent identifier, medium of interaction, length of interaction, interaction start and end time, department, tagged categories), and the application setting (e.g., the interaction path through the contact center). The analytic module 250 may retrieve such data from the storage device 220 for developing and training algorithms and models. It should be understood that, while the analytics module 250 is depicted as being part of a contact center, the functionality described in relation thereto may also be implemented on customer systems (or, as also used herein, on the “customer-side” of the interaction) and used for the benefit of customers.

The machine learning model 251 may include one or more artificial intelligence-based models, including machine learning models, such as neural networks, deep learning models as well as other types as described herein. As an example, the machine learning model 251 may be configured to predict behavior. Such behavioral models may be trained to predict the behavior of customers and agents in a variety of situations so that interactions may be personally tailored to customers and handled more efficiently by agents. As another example, the machine learning model 251 may be configured to predict aspects related to contact center operation and performance. In other cases, for example, the machine learning model 251 also may be configured to perform natural language processing and, for example, provide intent recognition and the like.

The analytics module 250 may further include an optimization system 252. The optimization system 252 may include one or more models 253, which may include the machine learning model 251, and an optimizer 254. The optimizer 254 may be used in conjunction with the models 253 to minimize a cost function subject to a set of constraints, where the cost function is a mathematical representation of desired objectives or system operation. Because the models 253 are typically non-linear, the optimizer 254 may be a nonlinear programming optimizer. It is contemplated, however, that the optimizer 254 may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like. The analytics module 250 may utilize the optimization system 252 as part of an optimization process by which aspects of contact center performance and operation are optimized or, at least, enhanced. This, for example, may include aspects related to the customer experience, agent experience, interaction routing, natural language processing, intent recognition, allocation of system resources, system analytics, or other functionality related to automated processes.

The various components, modules, and/or servers of FIG. 2 (as well as the other figures included herein) may each include one or more processors executing computer program instructions and interacting with other system components for performing the various functionalities described herein. Such computer program instructions may be stored in a memory implemented using a standard memory device, such as for example, a random-access memory (RAM), or stored in other non-transitory computer readable media, such as for example, a CD-ROM, flash drive, or some combination thereof. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the present invention. Further, the terms “interaction” and “communication” are used interchangeably, and generally refer to any real-time and non-real-time interaction that uses any communication channel including, without limitation, telephone calls (PSTN or VoIP calls), emails, vmails, video, chat, screen-sharing, text messages, social media messages, WebRTC calls, or some combination thereof. Access to and control of the components of the contact system 200 may be affected through user interfaces (UIs) which may be generated on the customer devices 205 and/or the agent devices 230. As already noted, the contact center system 200 may operate as a hybrid system in which some or all components are hosted remotely, such as in a cloud-based or cloud computing environment.

### Intent Health Optimization System for Conversational Bots

Modern day contact centers regularly employ automated processes, such as conversational bots in place of live agents. The structure and sequence of interactions between the conversational bot and its users is defined by a bot flow architecture. The bot flow architecture includes elements, such as a dialog flow definition, a natural language understanding (NLU) domain and a knowledge base. The bot flow architecture may be integrated with at least one of the modules or components of the contact center such as, the interactive media response (IMR) server 216 or the chat server 240 to construct conversational bots.

The conversational bot is typically trained by first defining intents and utterances by a bot author. Broadly, intents refer to customer goals or intentions that the bot needs to fulfil or respond to. Utterances denote the various ways in which a customer can describe these goals or intentions. Together, they form the NLU domain of the bot flow architecture. In order to train machine learning models for NLU, defining the right set of intents and utterances is of great importance.

Generally, NLU models report a variety of metrics to denote their performance like precision, recall, accuracy, etc. This is usually reported on a test data set containing intents and utterances, which is different from the data set used for training. While such metrics help understand and compare the overall performance of different models, they do not provide more granular information regarding the specific intents and utterances in the NLU domain that contribute to performance degradation. While confusion matrices on test data may help give some indication as to problematic intents, they do not prescribe any specific action on any utterance present in the NLU domain. The problem gets more severe when the number of intents and utterances present increases. In this regard, providing an overall number to indicate model performance may not be very useful for bot authors unless problematic entries in the NLU domain are identified and corrective actions are enabled that improve functionality.

The dialogue flow definition of the bot flow architecture helps orchestrate the dialogue between the bot and a customer. It may define the hierarchy or set of intents that need to be considered for detection at different turns of the conversation, as well as any the follow up questions that need to be asked to the customer to perform any data actions that are required for intent fulfilment.

The bot flow architecture may be designed to contain an associated knowledge base in addition to or in place of an NLU domain. The knowledge base defines a set of questions with associated answers, like an FAQ collection. If the bot needs to only detect such questions and provide static answers present in the knowledge base, then only a knowledge base needs to be present and not an NLU domain.

In the present disclosure, the bot flow architecture as described above is integrated with an Intent Health Optimization System (IHOS), to optimize intent health. As will be seen, this method identifies problematic entries in the NLU domain and takes corrective action by generating paraphrased utterances with healthy intents which replaces utterances linked to irrelevant intents in the NLU domain. Repopulating, existing utterances linked to unhealthy intents, with a diverse set of paraphrases with healthy intents without changing the contextual essence of the existing utterances leads to intent health optimization in a bot flow architecture thereby enhancing quality of conversation in conversational bots.

For example, an input utterance “I can't access account portal” may be replaced with a paraphrase “I am unable to log into my online account” which does not differ in context. Considering another example, the input utterance “help with password reset” may be replaced with the paraphrased utterance “What is the process for resetting my password” which does not vary the contextual essence of the input utterance.

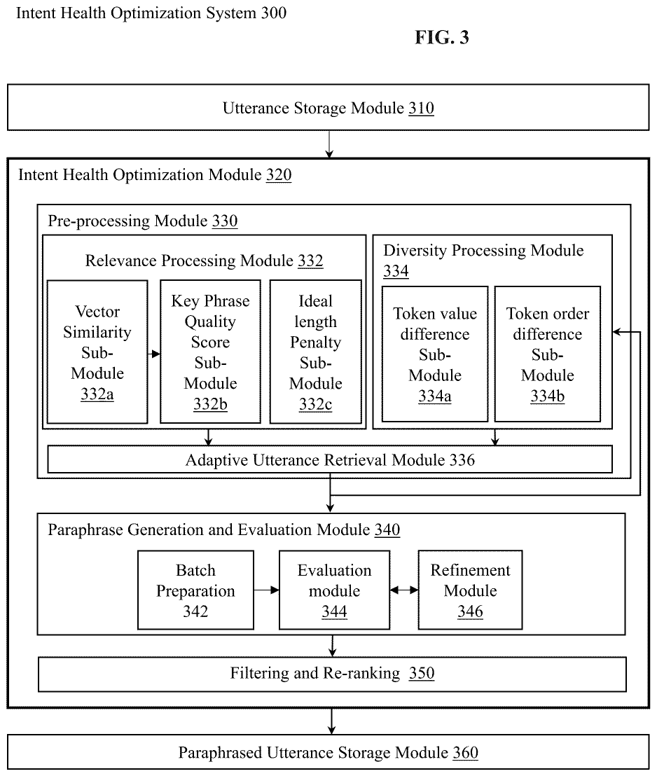

While the system and method described here is not tailored to any specific machine learning model that can be used for the purposes of natural language understanding, it may work best with those that use word embeddings or its variations as features. It should be understood that any of the computer-implemented components or modules described in relation to FIG. 3 or in any of the following figures may be implemented via types of computing devices, such as, for example, the computing device 100 of FIG. 1.

With reference now to FIG. 3, the IHOS 300 is shown in accordance with exemplary embodiments of the present invention and can be implemented in software only, hardware only, or a combination of hardware and software. Once a bot author creates a collection of intents and associated utterances and saves the NLU domain in an utterance storage module 310, and defines a dialog flow, a request may be sent by the bot author to validate the health of intents of a particular conversational bot and take corrective actions. In some embodiments the request to validate the health of intents may be automated based on creation or modification of the NLU domain by the bot author. The IHOS 300 operates in conjunction with the utterance storage module 310, an intent health optimization module (IHOM) 320, and a paraphrased utterance storage module 360. The IHOS system 300 depicted in FIG. 3 is merely an example arrangement of the various modules in the system. One of ordinary skill in the art would recognize many possible variations, alternatives, and modifications. For example, in some implementations, the IHOS system 300 may have additional modules, may combine modules, or may have a different configuration or arrangement of modules than those shown in FIG. 3.

Once the request to validate intents is received by the IHOS 300, the IHOM 320 may fetch a collection of input utterances belonging to the NLU domain of the bot from the utterance storage module 310. The input utterances which are grouped by specific intents may include a complete sentence, a fragmented sentence, or a combination of sentences, and the like. The IHOM 320 operates in conjunction with a preprocessing module 330, a paraphrase generation and evaluation module 340, and a filtering and reranking module 350.

The pre-processing module 330 processes the input utterances to select representative utterances from the input utterances. The pre-processing module 330 operates in conjunction with a relevance processing module 332 which determines an overall relevance score, a diversity processing module 334 which determines an overall diversity score, and an adaptive utterance retrieval module 336 which retrieves a selected representative utterance based on both the overall relevance score and the overall diversity score.

The relevance processing module 332, further includes a plurality of sub-modules, such as a vector similarity sub-module 332a, a key phrase quality score sub-module 332b and a non-ideal length penalty sub-module 332c.

The vector similarity sub module 332a, of the relevance processing module 332 receives the input utterances of the specific intent and determines a semantic similarity, which is the similarity in meaning between the input utterances of the specific intent. In an example embodiment, the vector similarity sub module 332a compresses the semantic information of the input utterances into a fixed-size vector, regardless of a length of the input utterance to generate embeddings. A pre-trained encoder type transformer model, such as E5, BERT and ROBERTa is utilized to generate the embeddings. The vector similarity sub module 332a further generates a centroid of the embeddings for a specific intent to create an intent representative vector. The intent representative vector enables representation of the specific intent in an embedding latent space when textual description for that intent is not present or is of insufficient quality.

The vector similarity sub module 332a may implement various techniques on the generated embeddings to determine semantic similarity S(u) between the input utterances. For example, cosine similarity is a popular technique which determines similarity between embeddings of the input utterances.

The key phrase quality sub module 332b, of the relevance processing module 332 receives the input utterances and determines a key phrase quality score which identifies context rich input utterances and assigns a high value of priority to the input utterances having high volume of context specific terminology. In an example embodiment, the key phrase quality score sub-module 332b extracts a set of candidate key phrases from the input utterances, where the key phrases are n in number. i.e., n grams where n is typically between two and three. Embeddings of the extracted candidate key-phrases are generated to obtain candidate key phrase vectors. Techniques to determine semantic similarity between the candidate key phrase vectors and the intent representative vector may be implemented by the key phrase quality score sub-module 332b and pairwise quality scores K(u) are generated. The quality of the candidate key-phrases may be determined by aggregating pairwise quality scores.

The candidate key phrases are assigned varying values of priority based on the quality of the candidate key-phrases. Such a priority allocation to the candidate key phrases of the input utterance may enable filtering out the input utterances which are relevant in a broad sense but lack domain specific intent.

The non-ideal length penalty sub-module 332c, of the relevance processing module 332 estimates the ideal length of the input utterance. In general, metrics which evaluate utterances tend to favor shorter paraphrases over longer paraphrases which can lead to vagueness. On the other hand, very long paraphrases overshadow other paraphrases, maybe even some with better contextual relevance. Thus, it is important to choose input utterances of ideal length to generate paraphrases with healthy intents.

The non ideal length sub module 332c receives the input utterances to estimate an ideal length of the input utterance and assigns a penalty to the input utterances which deviates from the estimated ideal length of the input utterance. In an example embodiment the ideal length of the input utterance with a specific intent is estimated through statistical processes, based on a length of all the input utterances for the specific intent. The non-ideal length penalty is evaluated based on how the length of the input utterance deviates from the estimated ideal length.

In another example embodiment, the non-ideal length penalty estimation is based on a symmetric exponential curve with parameters, such as the length of the input utterance (i), the estimated ideal length (l) and a penalty stringency (s). The penalty stringency (s) is a variable parameter which allows for varying the stringency of evaluating the non-ideal length penalty.

In an example embodiment, the non-ideal length penalty P(u) may be as follows:

$$P ( u ) = exp ( ( - \frac{1}{s} ) * {( 1 - \frac{i}{l} )}^{2} )$$

The relevance processing module 332, determines the overall relevance score R(u) of the input utterances based on parameters, such as the semantic similarity S(u), the key phrase quality score K(u) and the non-ideal length penalty P(u) or a combination thereof.

The diversity processing module 334, determines diversity of the input utterances based on either the lexical similarity, structural similarity, or a combination of both. Lexical similarity is established based on lexical content or similarity in words used in the utterances whereas structural similarity is established based on the word order of the utterances. The diversity processing module 334, includes a token value difference sub-module 334a and a token order difference sub-module 334b.

The token value difference sub-module 334a generates a token value difference which provides a measure of lexical dissimilarity between a candidate input utterance of the received input utterances and each of the previously selected representative utterances with the specific intent. The token value difference is evaluated based on the number of unique tokens not common to the candidate input utterance and each of the previously selected representative utterances of the specific intent.

In an example embodiment, token value difference sub-module 334a generates a list of tokens for the candidate input utterance and for each of the previously selected representative utterances of the specific intent. Further, a union operation is performed on the candidate input utterance token list with a token list for each of the previously selected representative utterances with the specific intent individually.

Further, an intersection operation is performed on the total tokens generated after the union operation to eliminate tokens which are common to both the candidate input utterance and each of the previously selected representative utterances. The final list after intersection is normalized to obtain the token value difference. The token value difference is proportional to the measure of dissimilarity between the candidate input utterance and the previously selected representative utterance. Thus, the token value difference increases with increase in dissimilar tokens and decreases with decrease in dissimilar tokens.

The token order difference sub-module 334b estimates similarity in an order between the candidate input utterance of the received input utterances and the previously selected representative utterance by utilizing a token order matching algorithm. The token order matching algorithm determines an anchor point, which is the longest contiguous matching sub sequence of the candidate input utterance and the previously selected representative utterance. Subsequent to determination of the anchor point, the token order matching algorithm is recursively applied to the portions before and after the anchor point. This results in matching blocks representing similarities between two sequences and is normalized to obtain the token order difference. The obtained token order difference value is directly proportional to the structural dissimilarity between the two sentences.

The diversity processing module 334 determines an overall diversity score D(u) which is based on the token value difference (V), the token order difference (O) and a control parameter β. The overall diversity score D(u) may be as follows:

$$D ( u ) = β * V + ( 1 - β ) * O$$

The outputs of the relevance processing module 332 and the diversity processing module 334 a received by the adaptive utterance retrieval module 336, which adaptively retrieves the selected representative utterance with the best intent based on the overall relevance score and the overall diversity score. The candidate input utterance with the highest relevance score out of n candidate utterances is selected as a first representative utterance. This selection enables inclusion of the most relevant utterance in the final list of utterances.

For the remaining utterances excluding the utterance with the highest relevance score, the adaptive utterance retrieval algorithm iteratively manipulates the overall diversity score which is the minimum of both the token value and token order difference obtained from the diversity processing module 334.

The candidate utterances are selected by the adaptive utterance retrieval module 336 to be included in the final set of selected representative utterances based on the overall diversity score D(u), the overall relevance score R(u) and an adaptively varying trade-off parameter γ. The final set of selected representative utterances F(u) may be evaluated as follows:

$$F ( u ) = γ * R ( u ) + ( 1 - γ ) * D ( u )$$

In an example embodiment varying a trade-off parameter may include assigning high priority to the overall relevance score during time periods from time t=t₀ which is the initial time interval till t=tₜₕ which is a threshold time closer to the initial time interval and assigning high priority to the diversity score as the number of candidate utterance increases. The adaptive variation of trade-off parameter balances relevance and diversity thereby leading to a final set of selected representative utterances with healthy intent along with capturing a wide range of linguistic variations.

The selected representative utterances are received by the paraphrase generation and evaluation module 340 which includes a batch preparation module 342 which groups the selected representative utterances into batches of common intent and utilizes a default model configuration such as, a large language model or a fine-tuned language model on the batches to generate an initial set of paraphrased utterances. Grouping based on a common intent enables multiple utterances to be processed by a single API model which may enhance efficiency of the bot flow architecture.

The initial set of paraphrased utterances are then evaluated by the evaluation module 344 based on control metrics, wherein the control metrics are an embedding similarity, a lexical variation, a syntactic variation, or a combination thereof. The paraphrase generation and evaluation module 340 further includes a refinement module 346 which in response to the evaluation, refines the initial set of paraphrased utterances.

The filtering and reranking module 350 filters the refined set of paraphrased utterances based on a readability assessment. The readability assessment may be carried out using a Flesch-Kincaid Level Score which evaluates the complexity of the refined set of paraphrased utterances and filters them based on a pre-defined threshold to eliminate complicated paraphrases out of the refined set of paraphrased utterances. Further, the filtering and re-ranking module utilizes an intent classification model to calculate a confusion score, indicating how likely is it for the refined set of paraphrased utterances be misclassified as belonging to a different intent. The refined set of paraphrased utterances with high confusion score are flagged and eliminated which helps in maintaining the integrity of the intent of the refined set of paraphrased utterances in the final dataset.

These filtering techniques enhance the quality of the final dataset ensuring that the resulting utterances are both easily understandable and accurately aligned with their intended meanings. Finally, the refined set of paraphrased utterances are reranked to obtain the paraphrased utterances with healthy intent.

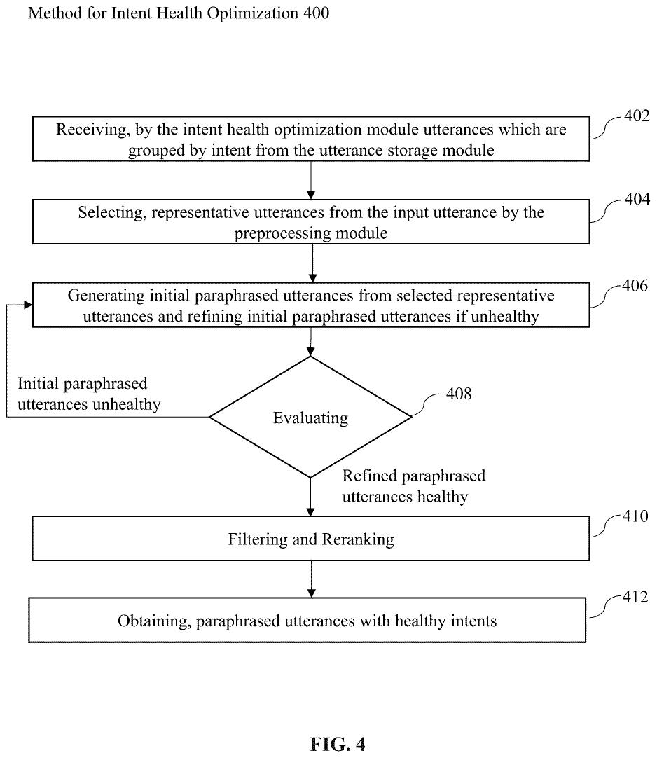

With reference to FIG. 4, a method 400 is depicted for intent health optimization in a bot flow architecture, in accordance with an exemplary embodiment of the present invention. In exemplary embodiments, the bot flow architecture may include a machine learning model trained for natural language understanding (NLU) within a NLU domain that is defined by a collection of intents and sets of associated utterances.

In accordance with exemplary embodiments the method for intent health optimization may be used to replace utterances linked to irrelevant intents/unhealthy intents with paraphrased utterances which are linked to relevant/healthy intents in the NLU domain, thereby improving performance in the bot flow architecture.

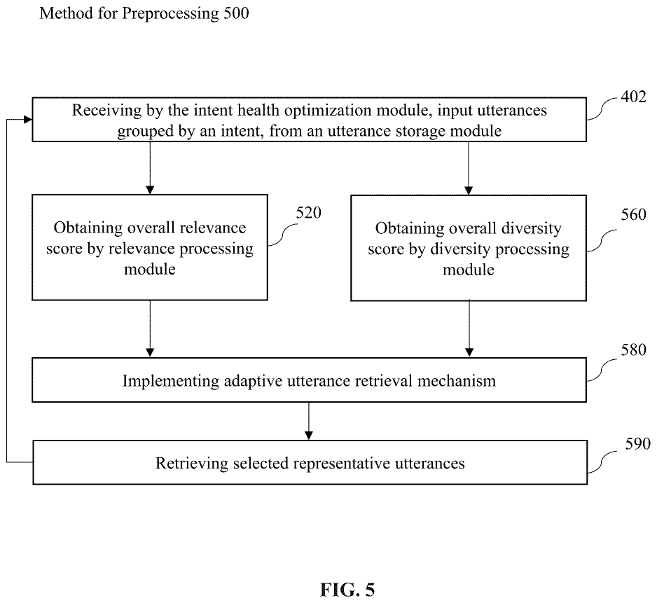

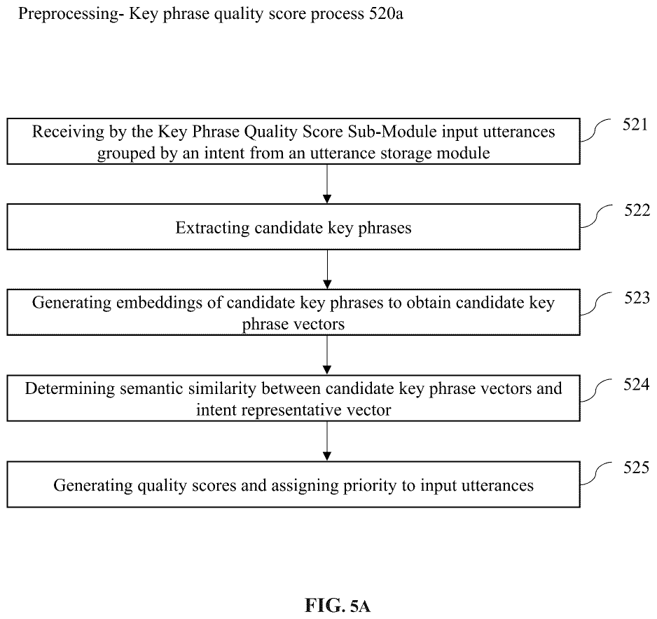

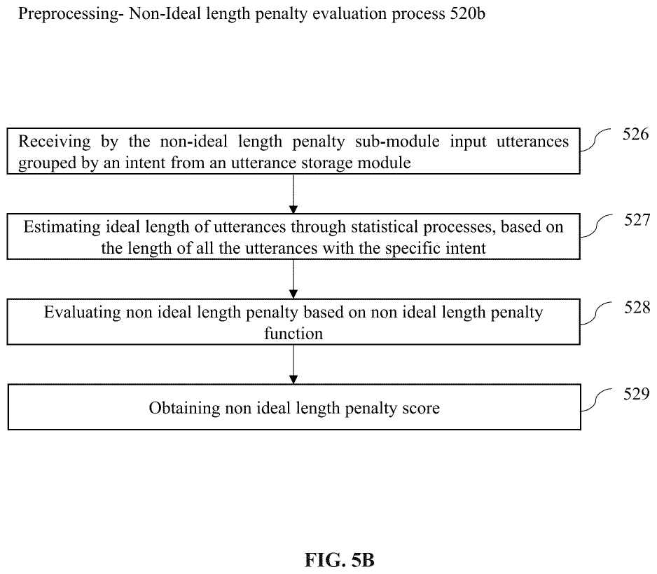

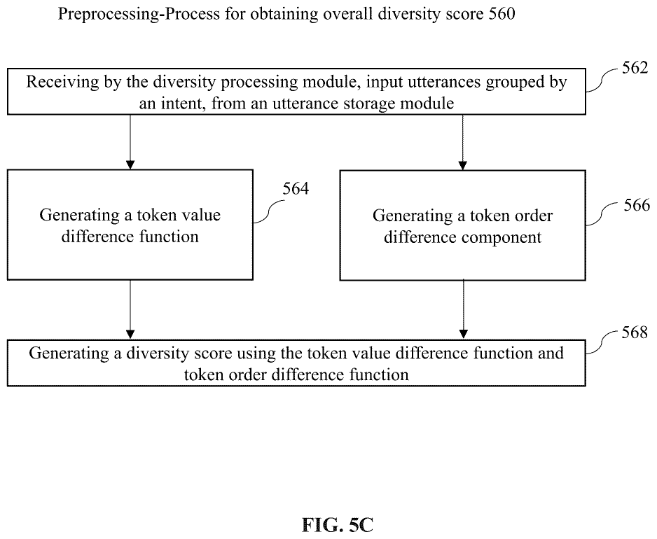

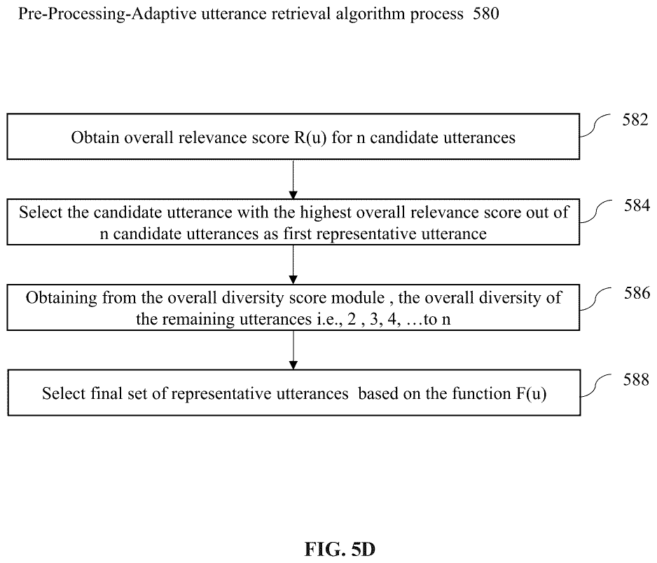

The method 400 begins, at step 402, by retrieving input utterances of the bot flow architecture which are grouped by intent from the utterance storage module. The retrieved utterances are then processed by the by the health optimization module. At 404, representative utterances from the input utterances are selected after preprocessing the input utterances. The method for preprocessing involves a plurality of steps as depicted in FIGS. 5-5D which is described in detail below. At 406, initial set of paraphrased utterances are generated from the selected representative utterances. Further at 408, the generated initial set of paraphrased utterances are evaluated based on parameters, such as the length of the paraphrase, relevance, and diversity. The evaluated initial set of paraphrased utterances are refined by paraphrase generation and evaluation module 340 if unhealthy intents are linked to the paraphrased utterances at 406. At 410, filtering and reranking is performed on the refined set of paraphrased utterances. At 412, the paraphrased utterances with healthy intents are obtained.

### Preprocessing

In accordance with exemplary embodiments, the method of preprocessing to select representative utterances from the input utterance is depicted in FIGS. 5 to 5D. The method involves receiving input utterances grouped by an intent, from an utterance storage module and obtaining the overall relevance score for the input utterances by relevance processing module at 520 and obtaining overall diversity score for the input utterances by diversity processing module at 560.

Obtaining the overall relevance score at 520 involves evaluating parameters, such as semantic similarity, the key phrase quality score, the non-ideal length penalty or any combination thereof.

The semantic similarity as described above, in relation to the IHOS, is determined by the vector similarity sub module 332a which compresses the semantic information of the input utterance into a fixed-size vector, regardless of a length of the input utterance to generate embeddings. Further, the vector similarity sub module 332a may implement various techniques on the generated embeddings to determine semantic similarity S(u) between utterances. For example, cosine similarity is a popular technique which determines similarity between embeddings of the input utterances.

The key phrase quality score is determined by key phrase quality sub module 332b which identifies context rich input utterances and assigns a high value of priority to the input utterances having high volume of context specific terminology. FIG. 5A is a flowchart illustrating a process 520a for determining the key phrase quality score, in accordance with certain embodiments. At 521, the input utterances which are grouped by intent are received by the key phrase quality score sub-module from the utterance storage module. At 522, candidate key phrases are extracted from the input utterances. At 523 embeddings are generated for the extracted candidate key phrases to obtain candidate key phrase vectors. Further at 524, the semantic similarity between the candidate key phrase vectors and the intent representative vector is determined. At 525, the pairwise quality scores are generated, and the input utterances are assigned priority which may be used to obtain the overall relevance score.

The non ideal length penalty is determined by the non-ideal length penalty sub module 332c, which receives the input utterances to estimate an ideal length of the input utterance and assigns a penalty to the input utterances which deviates from the estimated ideal length of the input utterance. FIG. 5B is a flowchart illustrating a process 520b for evaluating a non-ideal length penalty, in accordance with certain embodiments. At 526, the input-utterances which are grouped by intent are received by the non-ideal length penalty sub module from the utterance storage module. At 527, the ideal length of the utterance for a specific intent is estimated through statistical processes, based on the length of all the utterances with the specific intent. At 528 the non-ideal length penalty is evaluated using the non-ideal length penalty function. The non-ideal length penalty function is based on parameters, such as the length of input utterance (i), the estimated ideal length (l) and a penalty stringency (s). The penalty stringency (s) is a variable parameter which allows varying the stringency of evaluating the non-ideal length penalty. At 529, the non-ideal length penalty score is obtained and may be used to obtain the overall relevance score.

The overall relevance score is thus determined at 520, by determining parameters such as semantic similarity, a key phrase quality score using a process 520a depicted in FIG. 5A, a non-ideal length penalty using a process 520b depicted in FIG. 5B or any combination thereof.

The process for obtaining the overall diversity score 560, is depicted in FIG. 5C. At 562, the input utterances which are grouped by intent are received by the diversity processing module 334 from the utterance storage module 310. At 564, the token value difference which provides a measure of lexical dissimilarity between a candidate input utterance (n) and each of the previously selected representative utterances with a specific intent is generated. The token value difference is evaluated based on unique words or tokens not shared between the candidate input utterance and each of the previously selected representative utterances of specific intent. At 566, the token order difference which provides a measure of structural dissimilarity between a candidate input utterance (n) and each of the previously selected representative utterances with a specific intent is generated. At 568, an overall diversity score based (D) based on a token value difference (V), token order difference (O) and a control parameter β is determined. The determined overall diversity score is input to the adaptive utterance retrieval algorithm.

The overall relevance score generated at 520 and the overall diversity score generated at 560 is input to the adaptive utterance retrieval mechanism at 580. The implementation of the adaptive utterance retrieval algorithm 580 is depicted in FIG. 5D. At 582, overall relevance score R(u) is determined. At 584, the candidate input utterance with the highest relevance score is chosen as the first representative utterance among the n candidate utterances. At 586, the overall diversity score for the remaining candidate input utterances i.e., 2, 3, 4, . . . to n is obtained. At 588, the final set of representative utterances are selected based on the function F(u) which depends on both relevance and diversity. The selected representative utterances are output to the paraphrase generation and evaluation unit for further processing. The preprocessing module 330 outputs representative utterances at 590.

### Generation of Paraphrases

The selected representative utterance generated after the process of preprocessing are received by the paraphrase generation and evaluation module 340 to generate an initial set of paraphrased utterances. The initial set of paraphrased utterances are then evaluated by the evaluation module 344 based on control metrics, wherein the control metrics are an embedding similarity, a lexical variation, a syntactic variation, or a combination thereof. The paraphrase generation and evaluation module 340 further includes a refinement module 346 which in response to the evaluation, refines the initial set of paraphrased utterances.

The filtering and reranking module 350 filters the refined set of paraphrased utterances based on a readability assessment. The refined set of paraphrased utterances with high confusion score are flagged and eliminated which helps in maintaining the integrity of the intent of the refined set of paraphrased utterances in the final dataset. These filtering techniques enhance the quality of the final dataset ensuring that the resulting utterances are both easily understandable and accurately aligned with their intended meanings. Finally, the refined set of paraphrased utterances are reranked to obtain the paraphrased utterances with healthy intent.

As one of skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, each of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the present application as defined by the following claims and the equivalents thereof.

That which is claimed:

1. A method for determining representative utterances from input utterances to generate paraphrased utterances with healthy intents, the method comprising:
obtaining, by a relevance processing module an overall relevance score of the input utterances based on a vector similarity, a key phrase quality score, a non-ideal length penalty or any combination thereof;
obtaining, by a diversity processing module an overall diversity score between a candidate input utterance and previously selected representative utterances, based on both a token value difference and a token order difference; and
retrieving, by an adaptive utterance retrieval module selected representative utterances based on the overall relevance score and the overall diversity score.

2. The method of claim 1, wherein a refined set of paraphrased utterances are generated from the selected representative utterances by:
grouping, into batches, the selected representative utterances of a common intent and utilizing a default model configuration on the selected representative batches to generate an initial set of paraphrased utterances;
evaluating, the initial set of paraphrased utterances based on control metrics, wherein the control metrics are an embedding similarity, a lexical variation, a syntactic variation, or a combination thereof; and
in response to the evaluating, refining the initial set of paraphrased utterances.

3. The method of claim 2, wherein the refined set of paraphrased utterances are filtered and reranked to obtain paraphrased utterances with healthy intents by:
filtering, the refined set of paraphrased utterances based on a readability score;
in response to filtering, reranking the refined set of paraphrased utterances; and
assigning, a dynamic trade-off parameter to the reranked refined set of paraphrased utterances to obtain the paraphrased utterances with healthy intents wherein, the dynamic trade off parameter balances between relevance and diversity of the paraphrased utterances with healthy intents.

4. The method of claim 1, the wherein vector similarity is determined by generating embeddings of the input utterances, which are fixed-size dense vector representation of the input utterances.

5. The method of claim 4, wherein a centroid of the embeddings of the input utterances for the specific intent is generated to obtain an intent representative vector.

6. The method of claim 1, wherein determining the key phrase quality score further comprises:
extracting candidate key phrases from the input utterance;
generating embeddings of the extracted candidate key phrases to obtain candidate key phrase vectors;
estimating a semantic similarity between the candidate key phrase vector and the intent representative vector for the specific intent, to obtain pairwise quality scores; and
aggregating the top pair wise quality scores to obtain the key phrase quality score.

7. The method of claim 1, wherein determining the non-ideal length penalty includes estimating an ideal length of the input utterance based on a length of all the input utterances with the specific intent.

8. The method of claim 7, wherein determining the non-ideal length penalty includes varying a stringency parameter.

9. The method of claim 1, wherein evaluating the token value difference includes obtaining total tokens by performing a union operation of the candidate input utterance token list with a token list of each of the previously selected representative utterances with the specific intent.

10. The method of claim 9, wherein evaluating the token value difference includes performing an intersection operation on the total tokens obtained to eliminate tokens common to both the candidate input utterances and each of the previously selected representative utterances.

11. The method of claim 1, wherein evaluating the token order difference includes determining an anchor point for the input utterance by a token order matching algorithm and recursively applying the token order matching algorithm to portions before and after the anchor point.

12. The method of claim 1, wherein retrieving the selected representative utterance, includes determining the overall diversity of the all the relevant utterances except the utterance with the highest relevant score.

13. The method of claim 1, wherein retrieving the selected representative utterance includes adaptively varying a trade-off parameter.

14. The method of claim 13, wherein adaptively varying a trade-off parameter includes assigning high priority to the overall relevance score between time intervals t₀ to tₜₕ, wherein t₀ represents the initial time interval and tₜₕ represents a threshold time interval closer to the initial time interval.

15. The method of claim 13, wherein adaptively varying a trade-off parameter includes assigning high priority to the overall diversity score as the number of input utterance increases.

16. The method of claim 1, wherein the paraphrase generation and evaluation module, includes a Claude Large Language model or a Flan Model.
